(19) United States
(12) Patent Application Publication
(10) Pub. No.: US 2026/0169867 A1
(43) Pub. Date: Jun. 18, 2026

(54) BACKUP/RESTORE CONTROL SYSTEM AND BACKUP/RESTORE CONTROL METHOD

(71) Applicant: Hitachi Vantara, Ltd., Yokohama-shi (JP)

(72) Inventors: Masahiro Arai, Tokyo (JP); Akira Deguchi, Tokyo (JP); Takahiro Yamamoto, Tokyo (JP)

(73) Assignee: Hitachi Vantara, Ltd., Yokohama-shi (JP)

(21) Appl. No.: 19/325,598

(22) Filed: Sep. 11, 2025

(30) Foreign Application Priority Data
Dec. 17, 2024 (JP) 2024-221158

(51) Int. Cl. G06F 11/14

(52) U.S. Cl. CPC G06F 11/1469; G06F 11/1451; G06F 11/1464

(57) ABSTRACT

A backup/restore control system controls to create backup data of a volume to be backed up of a first storage system and store the backup data in a data store, and controls to store I/O statistical information related to I/O of the volume created by the first storage system while associating the backup data and the statistical information. In a case where the volume is restored using the backup data, the backup/restore control system selects a second storage system to be a restore destination of a first volume from a plurality of storage systems based on I/O statistical information, and controls to restore the volume to be restored from the backup data to the second storage system.

### BACKGROUND OF THE INVENTION

The present invention relates to a backup/restore control method and a backup/restore control system.

An operation form called a hybrid cloud in which an on-premises IT asset and a public cloud service are used in combination according to cost and application has appeared. The public cloud is characterized in that a necessary computer resource can be flexibly utilized by a metered amount charge as compared with the on-premises IT asset.

In recent years, as a utilization form of a public cloud, Active/Passive disaster recovery (DR) has appeared in which a backup of data is created in advance, necessary computer resources are allocated to restore data when at the time of disaster, and a recovery site (sub-site) is operated.

For example, Amazon Web Services, “Disaster Recovery (DR) Architecture on AWS, Part I: Strategies for Recovery in the Cloud”., [online], 5 Apr. 2021, [searched on: Oct. 17, 2024], Internet <URL: https://aws.amazon.com/jp/blogs/architecture/disaster-recovery-dr-architecture-on-aws-part-i-strategies-for-recovery-in-the-cloud/>discloses Backup & Restore as an example of an Active/Passive DR strategy (See FIG. 2, FIG. 3, etc.).

In addition, for example, JP 2024-10791 A discloses a method of backing up data in a cloud and restoring the data when necessary. Information identifying the volume of the backup source storage (e.g., a backup volume number) and the usage amount/provisioning size of the volume are saved as a catalog together with the backup data. At the time of restoration, it is possible to select a restore target and determine the capacity required for the restore destination storage by referring to these pieces of information.

### SUMMARY OF THE INVENTION

However, in the above-described conventional technology, the capacity of the restore destination storage and the I/O processing performance function appropriately if equal to or higher than those of the backup source storage.

However, in a case where the capacity of the restore destination storage and the I/O processing performance are inferior to those of the backup source storage, and it is necessary to restore the volume to be restored in a distributed manner in a plurality of storages, there is a problem that restoration cannot be performed in an appropriate storage.

The present invention has been made in view of the above circumstances, and an object thereof is to appropriately restore the volume to be restored in a distributed manner in a plurality of restore destination storages.

In order to achieve the above object, according to one aspect of the present invention, there is provided a backup/restore control system configured to control creation and restoration of backup of a volume included in a storage system, in which a processor included in the backup/restore control system is configured to control to create backup data of the volume to be backed up of a first storage system and store the backup data in a data store, control to store I/O statistical information related to I/O of the volume created by the first storage system while associating the backup data and the I/O statistical information, and control, in a case where a volume is restored using the backup data, to select a second storage system to be a restore destination of the volume from a plurality of storage systems based on the I/O statistical information, and restore a volume to be restored from the backup data to the second storage system.

According to the present invention, for example, the volume of the restore destination storage device can be restored in a distributed manner in a plurality of restore destination storage devices.

### BRIEF DESCRIPTION OF THE DRAWINGS

FIG. 1 is a diagram illustrating a configuration of an entire system according to a first embodiment;

FIG. 2 is a diagram illustrating a configuration of storage systems according to the first embodiment;

FIG. 3 is a diagram illustrating a configuration of a storage control program according to the first embodiment;

FIG. 4 is a diagram illustrating a configuration of a backup/restore control system according to the first embodiment;

FIG. 5 is a diagram illustrating the backup/restore control system executed by a plurality of computers according to the first embodiment;

FIG. 6 is a diagram illustrating a configuration of a backup/restore control program according to the first embodiment;

FIG. 7 is a diagram illustrating a configuration of a backup setting screen according to the first embodiment;

FIG. 8 is a diagram illustrating a configuration of a backup catalog according to the first embodiment;

FIG. 9 is a diagram illustrating a configuration of statistical information according to the first embodiment;

FIG. 10 is a diagram illustrating a configuration of a backup data store according to the first embodiment;

FIG. 11 is a flowchart illustrating backup processing according to the first embodiment;

FIG. 12 is a diagram illustrating a configuration of a restore setting screen according to the first embodiment;

FIG. 13 is a diagram illustrating a configuration of a statistical information screen according to the first embodiment;

FIG. 14 is a flowchart illustrating statistical information display processing according to the first embodiment;

FIG. 15 is a diagram illustrating a configuration of a backup/restore control program according to a second embodiment;

FIG. 16 is a diagram illustrating a configuration of a restore setting screen according to the second embodiment;

FIG. 17 is a flowchart illustrating recommendation degree determination processing according to the second embodiment;

FIG. 18 is a diagram illustrating a configuration of a recommendation determination condition table according to a second modified example of the second embodiment;

FIG. 19A is a diagram illustrating a configuration of a restore setting screen according to a third embodiment;

FIG. 19B is a diagram illustrating a configuration of a restore setting screen according to the third embodiment;

FIG. 20 is a diagram illustrating a configuration of a statistical information screen according to the third embodiment;

FIG. 21 is a flowchart illustrating recommendation degree update processing according to the third embodiment;

FIG. 22A is a diagram illustrating a screen change of a restore setting screen according to the third embodiment; and

FIG. 22B is a diagram illustrating a screen change of the restore setting screen according to the third embodiment.

### DESCRIPTION OF THE PREFERRED EMBODIMENTS

In the following description, an “interface device” may be one or more communications interface devices. The one or more communications interface devices may be one or more homogeneous communications interface devices (e.g., one or more Network Interface Cards (NIC)), or may be two or more heterogeneous communications interface devices (e.g., an NIC and a Host Bus Adapter (HBA)).

In the following description, a “memory” is one or more memory devices that are an example of one or more storage devices, and may typically be a main storage device. The at least one memory device in the memory may be a volatile memory device or a non-volatile memory device.

In the following description, a “disk” is a persistent storage device. The persistent storage device may typically be a nonvolatile storage device (e.g., an auxiliary storage device), and may specifically be, for example, a Hard Disk Drive (HDD), a Solid State Drive (SSD), or a Non-Volatile Memory Express (NVMe) drive.

In addition, in the following description, a “processor” may be one or more processor devices. The at least one processor device may typically be a microprocessor device such as a Central Processing Unit (CPU), but may be another type of processor device such as a Graphics Processing Unit (GPU). The at least one processor device may be single-core or multi-core. The at least one processor device may be a processor core. The at least one processor device may be a processor device in a broad sense, such as a hardware circuit (e.g., a Field-Programmable Gate Array (FPGA), a Complex Programmable Logic Device (CPLD), or an Application Specific Integrated Circuit (ASIC)) that performs some or all the processing.

Furthermore, in the following description, processing may be described with a “program” as a subject. The program is executed by the processor to perform predetermined processing while appropriately using the storage device and/or the interface device. Therefore, the subject of the processing may be a processor (alternatively, a device such as a controller having the processor). The program may be installed in a device such as a computer from a program source. The program source may be, for example, a program distribution server or a computer-readable (for example, non-transitory) recording medium. In the following description, two or more programs may be implemented as one program, or one program may be implemented as two or more programs.

In addition, in the following description, information from which an output is obtained with respect to an input may be described by an expression such as “xxx table”. However, the information may be data of any structure (e.g., the data may be structured data or unstructured data), or may be a learning model represented by a neural network, a genetic algorithm, or a random forest that generates an output with respect to an input. Therefore, the “xxx table” can be referred to as “xxx information”. Furthermore, in the following description, the configuration of each table is an example, and one table may be divided into two or more tables, or all or a part of two or more tables may be one table.

Furthermore, in the following description, processing may be described with a “program” as a subject. However, the program is executed by the processor to perform predetermined processing while appropriately using the storage device and/or the interface device. Therefore, the subject of the processing may be a processor (alternatively, a device such as a controller having the processor). The program may be installed in a device such as a computer from a program source. The program source may be, for example, a program distribution server or a computer-readable (e.g., non-transitory) recording medium. In the following description, two or more programs may be implemented as one program, or one program may be implemented as two or more programs.

In the following description, in a case where a plurality of the same components are to be distinguished from each other, reference numerals in which different branch numbers are assigned to the same reference numeral body will be used. On the other hand, in a case where the plurality of the same components are not distinguished, description will be made using only the same reference numeral body.

### First embodiment

In the first embodiment, a configuration in which statistical information regarding a target volume is acquired and saved together with backup data at the time of backup of a volume of a storage, and the statistical information is provided so as to be referable at the time of restoration will be described.

### Configuration of Entire System S According to First Embodiment

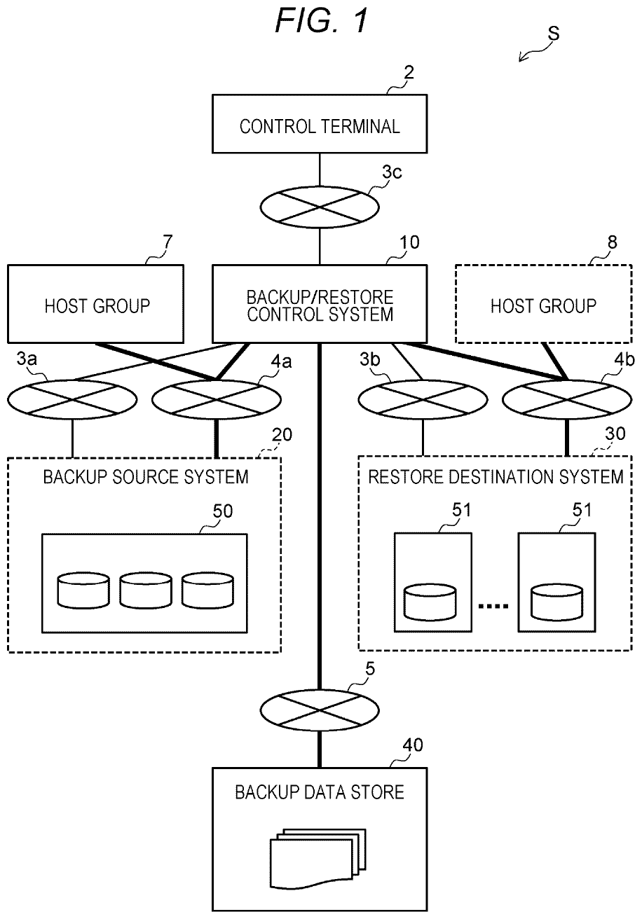

FIG. 1 is a diagram illustrating a configuration of an entire system S according to a first embodiment. The entire system S includes a control terminal 2, host groups 7 and 8, a backup/restore control system 10, a backup source system 20, a restore destination system 30, and a backup data store 40.

The backup/restore control system 10 manages backup/restore according to the first embodiment. The backup/restore control system 10 is connected to the backup source system 20 via a network 3a and a data access network 4a.

The backup source system 20 is a storage system that stores data serving as a backup source in the present embodiment, and includes at least one storage system 50. The storage system 50 provides the host group 7 with a logical volume serving as a secondary storage area in an accessible manner through the data access network 4a.

In addition, the backup/restore control system 10 is connected to the restore destination system 30 via a network 3b and a data access network 4b. The restore destination system 30 is a storage system serving as a restore destination in the present embodiment, and includes at least one storage system 51.

Note that in the present embodiment, for the sake of convenience of description, it is assumed that there are a plurality of storage systems 51, and the capacity of each storage system 51 is small as compared with that of the storage system 50.

The storage system 51 provides the host group 8 with a logical volume in an accessible manner via the data access network 4b. The host group 8 may be the same as the host group 7 or may be installed on demand when necessary.

Furthermore, the backup/restore control system 10 is connected to the backup data store 40 via a communication network 5. The backup data store 40 is a storage area for storing backed up data, and is, for example, a file storage such as a Network Attached Storage (NAS), an object storage, a server that provides a proprietary storage area, or the like.

In addition, the backup/restore control system 10 is connected to the control terminal 2 via a network 3c. The control terminal 2 is a terminal used by the user to input an instruction to the backup/restore control system 10 via a Graphical User Interface (GUI) or a Command Line Interface (CLI), and is, for example, a Personal Computer (PC) or a tablet terminal. The control terminal 2 includes a display unit that displays various GUIs described later.

Note that the backup/restore control system 10, the backup source system 20, the restore destination system 30, and the backup data store 40 may be disposed at the same site or partially disposed at a remote site such as a cloud. For example, the backup/restore control system 10 and the backup source system 20 may be placed in a data center owned by a user, and the restore destination system 30 and the backup data store 40 may be placed in a cloud. In addition, depending on the arrangement of each system, a part of the networks 3a to 3c and 4a, 4b, and 5 may be configured as a common network. Furthermore, the backup/restore control system 10 may be configured as a part of the backup source system 20 and the restore destination system 30.

### Configuration of Storage Systems 50 and 51 According to First Embodiment

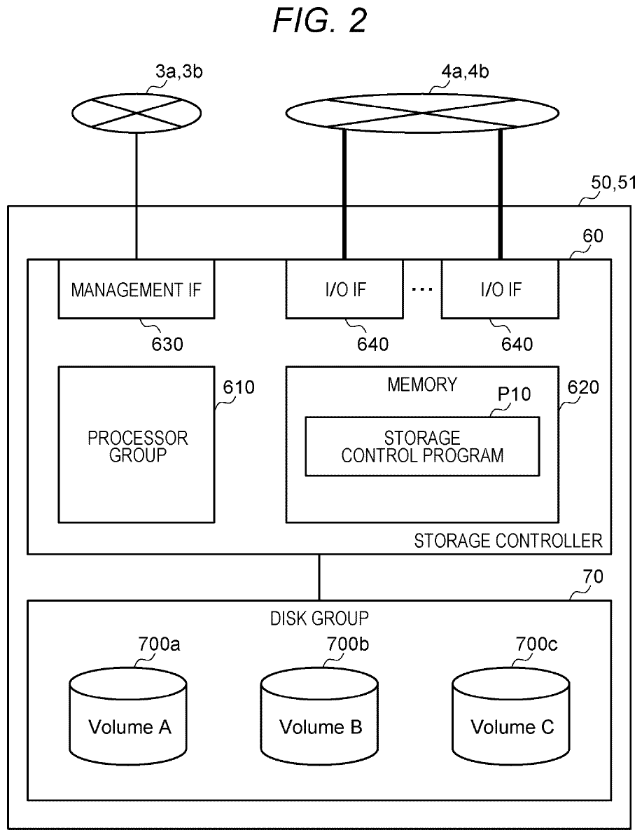

FIG. 2 is a diagram illustrating a configuration of the storage systems 50 and 51 according to the first embodiment.

The storage systems 50 and 51 are configured to include a storage controller 60 that performs various types of control and a disk group 70 that stores data.

The storage controller 60 includes a processor group 610, a memory 620, a management Inter Face (IF) 630, and an I/O IF 640 for data access. Although only one storage controller 60 is illustrated in FIG. 2, a plurality of storage controllers may be provided to improve availability, connectivity, and performance.

The processor group 610 is a plurality of processors including, for example, a CPU, a Graphics Processing Unit (GPU), an Artificial Intelligence (AI) operation chip, and the like, and executes the storage control program P10 on the memory 620 to perform various operations. The memory 620 is, for example, a Dynamic Random Access Memory (DRAM), and caches various operation results, data read from the disk group 70, and data stored in the disk group 70.

The management IF 630 is an interface for connecting to the networks 3a and 3b, and is used to exchange various instructions to the storage control program P10 and responses thereof. The networks 3a and 3b are constructed using, for example, a Local Area Network (LAN) or a mobile network.

The I/O IF 640 is an interface for connecting to the data access networks 4a and 4b, and is used to exchange data between the host group 7 or the backup/restore control system 10 and the storage controller 60. For communication of the data access networks 4a and 4b, for example, iSCSI, Fibre Channel, or the like is used.

The disk group 70 is a plurality of disks including a nonvolatile physical storage medium and the like, and is, for example, a Solid State Drive (SSD), a Hard Disk Drive (HDD), or the like. The disk group 70 is connected to the storage controller 60 and controlled by the storage controller 60.

Logical volumes 700a to 700c are storage areas logically configured on the disk group 70 under the control of the storage controller 60. The logical volumes 700a to 700c are configured to be distributed so as to be protected from loss by a technology such as, for example, Redundant Arrays of Inexpensive Disks (RAID). The number of the logical volumes 700 is not limited to three of the logical volumes 700a to 700c. In addition, a technology such as Thin Provisioning or a technology such as compression or deduplication may be applied to the logical volume 700 so that the storage capacity can be efficiently used.

Note that the storage systems 50 and 51 may be configured as devices using physical hardware, or may be constructed using a virtual machine configured on a hypervisor or computer resources on a cloud.

Furthermore, the storage systems 50 and 51 may be configured as a node coupled storage system constructed by network connecting a plurality of storage systems to each other.

### Configuration of Storage Control Program P10 According to First Embodiment

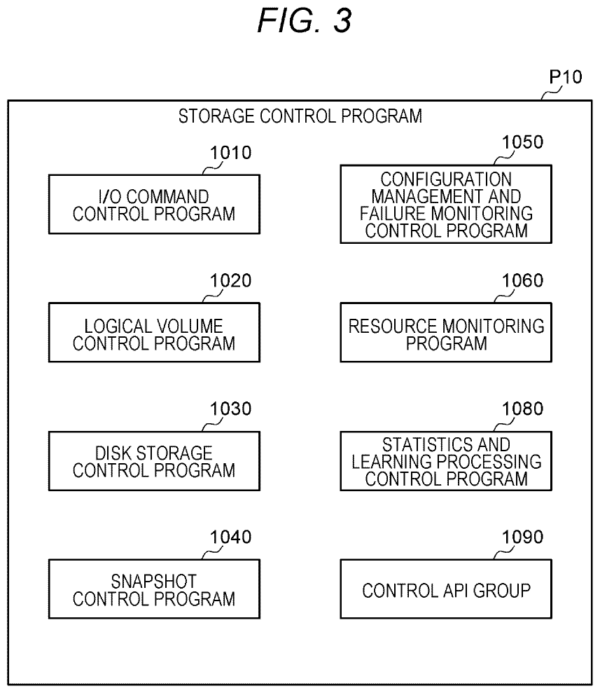

FIG. 3 is a diagram illustrating a configuration of the storage control program P10 according to the first embodiment.

The storage control program P10 includes an I/O command control program 1010, a logical volume control program 1020, a disk storage control program 1030, and a snapshot control program 1040. In addition, the storage control program P10 includes a configuration management and failure monitoring control program 1050, a resource monitor program 1060, a statistics and learning processing control program 1080, and a control Application Programming Interface (API) group 1090. The storage control program P10 operates in the storage systems 50 and 51.

The I/O command control program 1010 interprets I/O commands such as read and write from the host group 7 and the backup/restore control system 10, and performs processing of exchanging data via the data access network 4.

The logical volume control program 1020 performs processing related to overall access to the logical volume 700, such as creation and deletion of the logical volume 700, caching of data to the memory 620, and monitoring of the capacity of the logical volume 700.

The disk storage control program 1030 performs processing of converting read/write from/to the logical volume 700 into read/write to/from a disk in consideration of a configuration such as the RAID.

The snapshot control program 1040 is a function of creating a still image (Point in Time copy or snapshot) at a certain time point of the logical volume 700, and is used to acquire a volume in which update stop of data is guaranteed at the time of backup. In general, a running volume (i.e., a volume updated at any time) may be rewritten during backup and cannot be directly backed up, and hence a backup is created using a still image (snapshot) of the volume.

The configuration management and failure monitoring control program 1050 holds setting information related to the configurations of the storage systems 50 and 51 and monitors the presence or absence of a failure of each part of the storage systems 50 and 51. The resource monitor program 1060 monitors a processor load and a memory usage of the storage controller 60, an I/O amount from each host of the host group 7, and a time-series change in the I/O amount of each logical volume 700.

The statistics and learning processing control program 1080 performs necessary statistical processing on data acquired by the resource monitor program 1060, and performs tendency analysis, future prediction, and abnormality detection by performing machine learning.

The control API group 1090 receives an instruction to the storage control program P10 performed via the management IF 630, reflects the instruction to each control by the storage control program P10, and responds with a reflection result of the instruction.

### Configuration of Backup/Restore Control System 10 According to First Embodiment

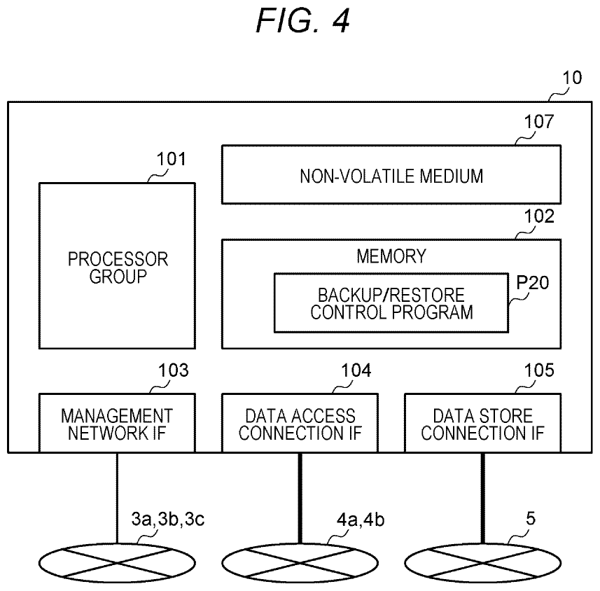

FIG. 4 is a diagram illustrating a configuration of the backup/restore control system 10 according to the first embodiment.

The backup/restore control system 10 is a general computer, and includes a processor group 101, a memory 102, a network IF 103, a data access connection IF 104, a data store connection IF 105, and a nonvolatile medium 107.

The processor group 101 is a plurality of processors including, for example, a CPU, a GPU, an AI operation chip, and the like, and executes a backup/restore control program P20 on the memory 102 to perform various operations. The memory 102 is, for example, a DRAM or the like, and is used to temporarily store various operation results and transfer data between interfaces.

The network IF 103 is an interface for exchanging an instruction to the storage control program P10 and a response thereof, or exchanging an instruction and a response thereof from the control terminal 2 to the backup/restore control program P20 via the networks 3a to 3c. The network IF 103 is, for example, an NIC. Note that similarly to 3a and 3b, the network 3c is constructed using, for example, a LAN or a mobile network.

The data access connection IF 104 is an interface for issuing read I/O and write I/O to the storage system 50 of the backup source system 20 and the storage system 51 of the restore destination system 30 to read and write the logical volume 700 via the data access networks 4a and 4b. The data access connection IF 104 is, for example, an NIC, an HBA, or the like.

The non-volatile medium 107 is, for example, an SSD, an NVRAM, or the like, and is used for storage of the main body or setting information of the backup/restore control program P20, caching of backup information, or the like.

The backup/restore control system 10 may be configured as a device using physical hardware, or may be configured using a virtual machine configured on a hypervisor. In addition, the backup/restore control system 10 may be constructed using computer resources on a cloud. In addition, the backup/restore control system 10 is described as one computer system in FIG. 4, but may be configured to be distributed to a plurality of computers.

### Backup/Restore Control System 10 Executed by a Plurality of Computers According to First Embodiment

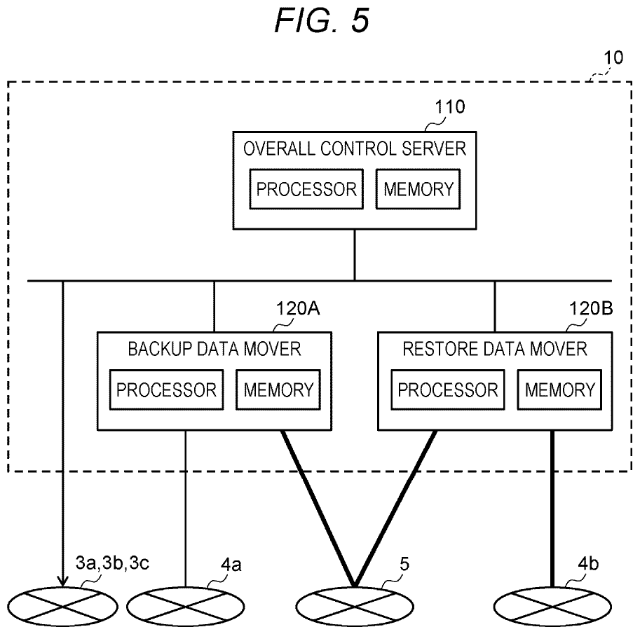

FIG. 5 is a diagram illustrating a backup/restore control system 10 executed by a plurality of computers according to the first embodiment.

The backup/restore control system 10 is configured to include an overall control server 110, a backup data mover 120A, and a restore data mover 120B. Each of the overall control server 110, the backup data mover 120A, and the restore data mover 120B includes a processor and a memory.

The overall control server 110 is connected to the networks 3a to 3c, the backup data mover 120A, and the restore data mover 120B, and instructs overall management and control. The backup data mover 120A is connected to the backup source system 20 and the backup data store 40, and processes data transfer at the time of backup between the backup source system 20 and the backup data store 40 based on an instruction of the overall control server 110. The restore data mover 120B is connected to the restore destination system 30 and the backup data store 40, and processes data transfer at the time of restoration between the restore destination system 30 and the backup data store 40 based on an instruction of the overall control server 110.

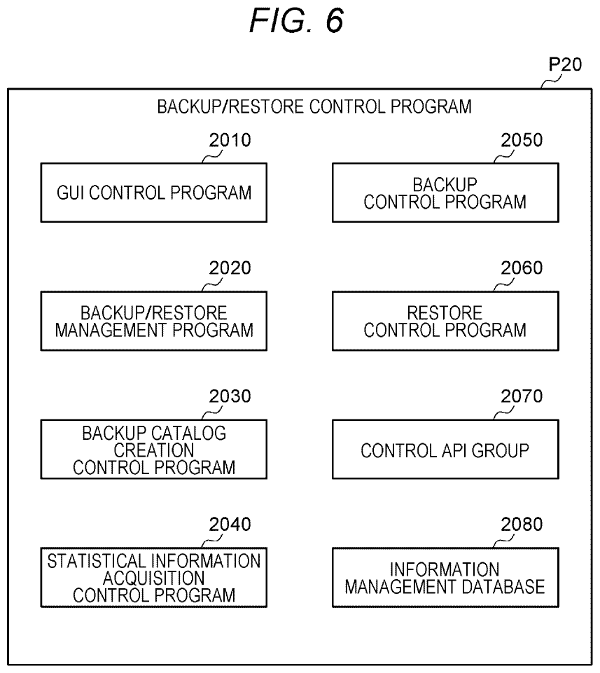

In the overall control server 110, the backup data mover 120A, and the restore data mover 120B, the backup/restore control program P20 (FIGS. 4 and 6) operates and executes processing corresponding to each purpose in cooperation.

### Configuration of Backup/Restore Control Program P20 According to First Embodiment

FIG. 6 is a diagram illustrating a configuration of the backup/restore control program P20 according to the first embodiment.

The backup/restore control program P20 includes a GUI control program 2010, a backup/restore management program 2020, a backup catalog creation control program 2030, and a statistical information acquisition control program 2040. In addition, the backup/restore control program P20 includes a backup control program 2050, a restore control program 2060, a control API group 2070, and an information management database 2080. The backup/restore control program P20 operates in the backup/restore control system 10.

The GUI control program 2010 draws and provides an operation GUI via the control terminal 2 in cooperation with other controls. The backup/restore management program 2020 performs an overall flow management processing of the backup/restore control program P20. This management processing includes, for example, schedule execution management of backup, control instruction to the storage systems 50 and 51 in each backup and restore, and exchange of user setting contents via the GUI control program 2010. The management processing also includes an instruction to the backup control program 2050 and the restore control program 2060, and an instruction to acquire and create various management information via the backup catalog creation control program 2030 and the statistical information acquisition control program 2040.

The backup catalog creation control program 2030 acquires necessary information and creates a backup catalog at the time of the backup processing. The backup catalog includes a volume number and a defined capacity for identifying the logical volume 700 which is the backup source, a data size that is actually backed up, a date and time when the backup is performed, and the like. The backup catalog will be described later.

The statistical information acquisition control program 2040 determines a period for aggregating statistics based on the previous backup date and time, and acquires period statistical data related to I/O processing of the backup source logical volume from the storage system 50.

Note that there is a difference in that the information of the backup catalog is instantaneous information at the time of the backup processing, whereas the information acquired by the statistical information acquisition control program 2040 is information indicating the trend of the entire period including the time zone in which the backup processing is not performed.

The backup control program 2050 reads an update block group included in the logical volume 700 of the backup source, and writes backup data to the backup data store 40 through a known method together with metadata including storage position information of the block and the like. In addition to the backup data, the backup control program 2050 saves the backup catalog and the statistical information in the backup data store 40 in association with each other according to an instruction of the backup/restore management program 2020.

The restore control program 2060 reads designated backup data from the backup data store 40, interprets metadata, and writes a block group to the logical volume 700 of the restore destination. In addition, the restore control program 2060 acquires a backup catalog and statistical information stored in the backup data store 40 according to an instruction of the backup/restore control program P20.

The control API group 2070 performs processing of interpreting contents instructed via the control terminal 2.

The information management database 2080 manages various information related to the backup/restore control program P20. The information managed by the information management database 2080 includes, for example, backup schedule information and replication (cache) of a backup catalog and statistical information stored in the backup data store 40.

### Configuration of Backup Setting Screen D30 According to First Embodiment

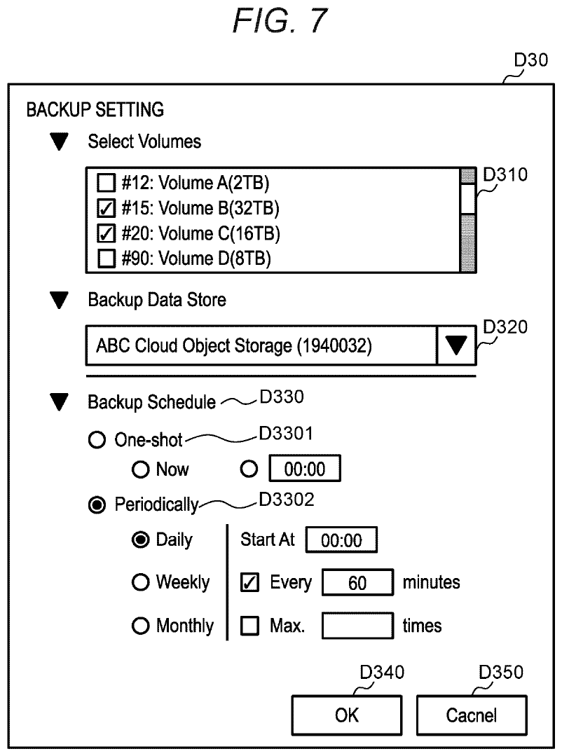

FIG. 7 is a diagram illustrating a configuration of a backup setting screen D30 according to the first embodiment. The backup setting screen D30 is provided by the GUI control program 2010 of the backup/restore control system 10.

The backup setting screen D30 includes a logical volume selection region D310, a backup data store selection region D320, and a backup schedule setting region D330.

The logical volume selection region D310 is a region for selecting the logical volume 700 to be backed up. In the example of FIG. 7, in the logical volume selection region D310, two logical volumes 700 of a volume B (32 TB) indicated by a logical volume number 15 and a volume C (16 TB) indicated by a logical volume number 20 are selected as backup targets.

The backup data store selection region D320 includes, for example, a drop-down box, and is a region for selecting the backup data store 40 as a backup storage destination of the logical volume 700. In the backup data store selection region D320, the backup data stores 40 are registered in advance using another management screen (not illustrated) and displayed in a selectable manner. In the example of FIG. 7, the object storage indicated by “ABC Cloud Object Storage (1940032)” is selected as the backup data store 40.

The backup schedule setting region D330 is a region for setting a backup schedule. In the backup schedule setting region D330, for example, a One-shot designation button D3301 for setting execution of a one-time backup and a Periodically designation button D3302 for setting execution of a periodic backup are displayed.

Note that when the One-shot designation button D3301 is selected, it is possible to select whether to immediately execute (Now) or to designate the execution start time and then execute. In addition, when the Periodically designation button D3302 is selected, it is possible to designate a repetition interval (e.g., daily, weekly, monthly), periodic execution by designating the execution start time and the execution interval time, repeated execution by designating the maximum number of executions, and the like. In the example of FIG. 7, as the backup schedule, the periodic execution is selected, and it is designated that the execution is performed daily and the execution is performed every 60 minutes from 0:00 every day.

### Configuration of Backup Catalog 420B According to First Embodiment

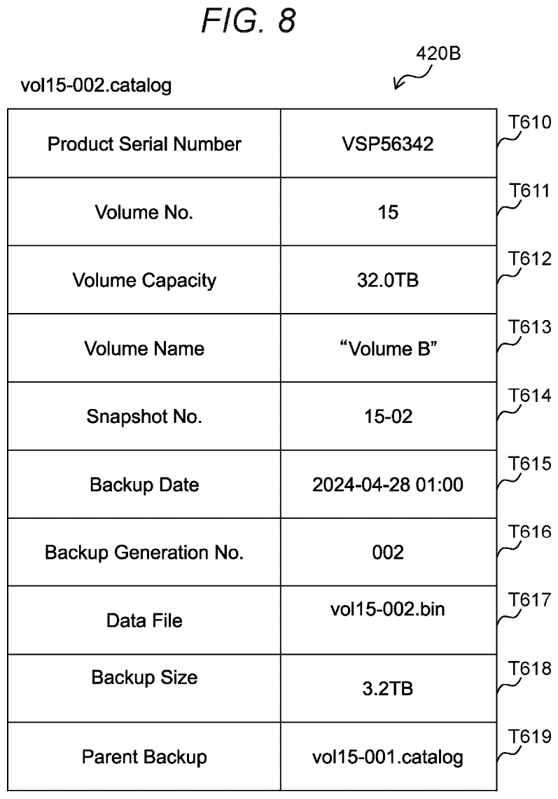

FIG. 8 is a diagram illustrating a configuration of the backup catalog 420B according to the first embodiment. The backup catalog 420B is created when the backup is completed, and stores various types of information for identifying a target at the time of restoration.

For example, as illustrated in FIG. 8, the backup catalog 420B is stored in the backup data store 40 with a file name of “vol15-002.catalog”. In the backup catalog 420B, a device product number T610, a volume number T611 of the logical volume 700 of the backup target, a defined capacity (allocated capacity) T612, a name T613, and a Snapshot number T614 used to acquire a still image are recorded. Furthermore, in the backup catalog 420B, a backup acquisition date and time T615, a generation number T616 of the backup, a file name T617 of the backup data, a backup capacity T618, and a backup catalog T619 of the backup of the parent generation are recorded. It can be seen from the information of the backup catalog 420B that the backup of “vol15-002.catalog” is a backup related to the logical volume number 15 of the device with the device product number “VSP56342”, the defined capacity of the volume is “32 TB”, and the volume name is “Volume B”.

In addition, in this backup, Snapshot indicated by a Snapshot number 15-02 is used as a still image (copy) of a logical volume number 15, and the acquisition date and time is “2024-04-28 01:00”. Furthermore, in this backup, the backup generation is stored as “002” and the read binary data is stored as a file name “vo15-002.bin”, and it can be seen that a capacity of 3.2 TB is required when restored. In addition, in this backup, there is a backup of the parent generation, and the “vol15-001.catalog” can be referred to for the contents.

Note that the backup catalog 420B may be stored in the backup data store 40 or may be held by the backup/restore control system 10. The holding format at that time may be a format such as a record of a database instead of a file.

### Configuration of Statistical Information 420C According to First Embodiment

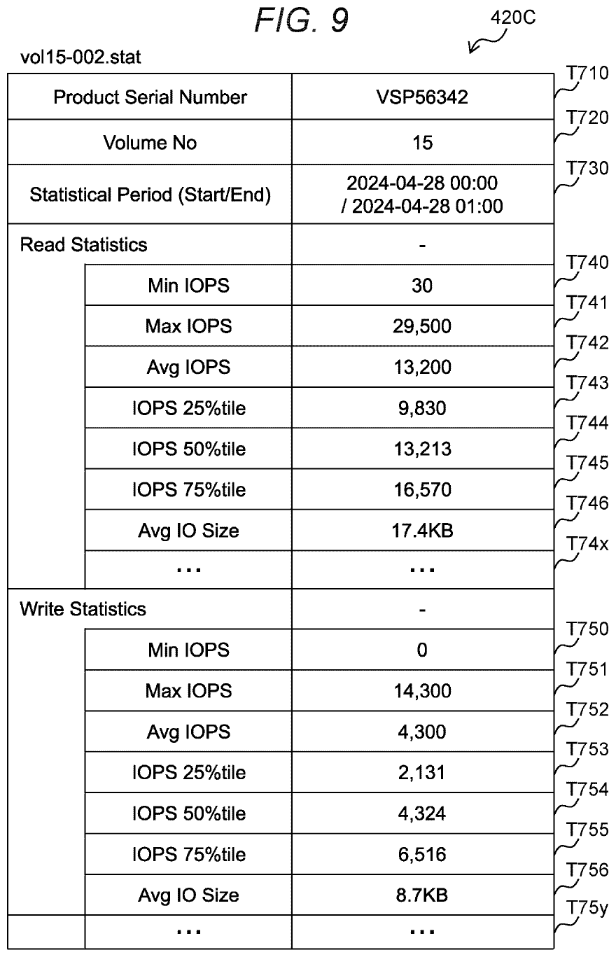

FIG. 9 is a diagram illustrating a configuration of statistical information 420C according to the first embodiment. The statistical information 420C stores statistical information related to I/O acquired over a predetermined period from the backup source system 20 at the time of backup.

The statistical information 420C is stored in the backup data store 40 under, for example, the file name “vol15-002.stat”. In the statistical information 420C, a device serial number T710, a logical volume number T720 of a statistics target, a statistics start/end period T730, statistical information T740 to T74x, . . . related to read I/O, and statistical information T750 to T75y, . . . related to write I/O are recorded.

The statistical information T740 . . . related to read I/O includes a minimum IO Per Second (IOPS) T740, maximum IOPS T741, average IOPS T742, 25% percentile value T743, . . . , 75% percentile value T745, and average IO size T746 . . . .

Similarly, the statistical information T750 . . . related to the write I/O includes a minimum IOPS T750, a maximum IOPS T751, an average IOPS T752, a 25% percentile value T753, . . . , a 75% percentile value T755, an average IO size T756, and the like.

It can be seen that the statistical information 420C illustrated in FIG. 9 is, for example, statistical information of a period from “2024-04-28 00:00” to “2024-04-28 01:00” with respect to the logical volume number 15 of the device serial number “VSP56342”. That is, it is statistics in the past one hour of the volume backed up in “2024-04-28 01:00” illustrated in FIG. 8. As illustrated in FIG. 7, since the main backup is performed every 60 minutes, the statistical information 420C illustrated in FIG. 9 is information indicating the trend in the period from the previous backup to the current backup.

In addition, the statistical information 420C illustrated in FIG. 9 indicates that the minimum IOPS of read (READ) is 30, the maximum IOPS is 29,500, the average value is 13,200, the 25% percentile value is 9,830, the 50% percentile value (median value) is 13,213, and the 75% percentile value is 16,570. In addition, in the statistical information 420C illustrated in FIG. 9, it can be seen that the average IO size is 17.4 KB.

Similarly, it can be seen that the minimum IOPS of write (WRITE) is 0, the maximum IOPS is 14,300, the average value is 4,300, the 25% percentile value is 2,131, the 50% percentile value (median value) is 4,324, and the 75% percentile value is 6,516. In addition, it can be seen that the average IO size is 8.7 KB.

Note that the statistical information 420C may include statistics related to a throughput (MB/s), a histogram related to an I/O size, statistics related to an I/O command (e.g., a Trim command) other than read and write, and the like.

### Configuration of Backup Data Store 40 According to First Embodiment

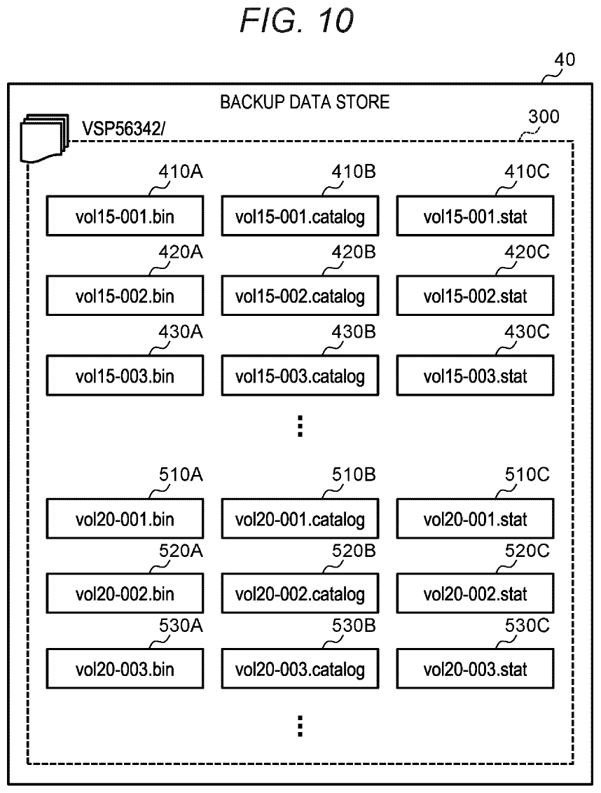

FIG. 10 is a diagram illustrating a configuration of the backup data store 40 according to the first embodiment. FIG. 10 schematically illustrates a state in which the backup data, the backup catalog, and the statistical information are stored in the backup data store 40.

In the backup data store 40, a region 300 having a device serial number that is unique information as a folder name (or a prefix in the object storage) is configured. The backup data store 40 stores backup data 410A, 420A, and 430A related to the logical volume number 15, and backup catalogs 410B, 420B, and 430B and statistical information 410C, 420C, and 430C corresponding thereto, respectively. Similarly, the backup data store 40 stores backup data 510A, 520A, and 530A related to the logical volume number 20, and backup catalogs 510B, 520B, and 530B and statistical information 510C, 520C, and 530C corresponding thereto, respectively.

In the example of FIG. 10, the region 300 is “VSP56342/”, the backup data of the first generation backup of the logical volume number 15 is “vol15-001.bin”, the backup catalog is “vol15-001.catalog”, and the statistical information is “vol15-001.stat”. Similarly, second generation and third generation backup data, backup catalog, and statistical information are stored. As described above, regarding the backup data, the backup catalog, and the statistical information, the mutual relevance can be recognized from the first half of the file name and the classification (any of backup data, a backup catalog, and statistical information) can be recognized from the extension of the second half. The same applies to the backup of the logical volume number 20.

### Backup Processing According to First Embodiment

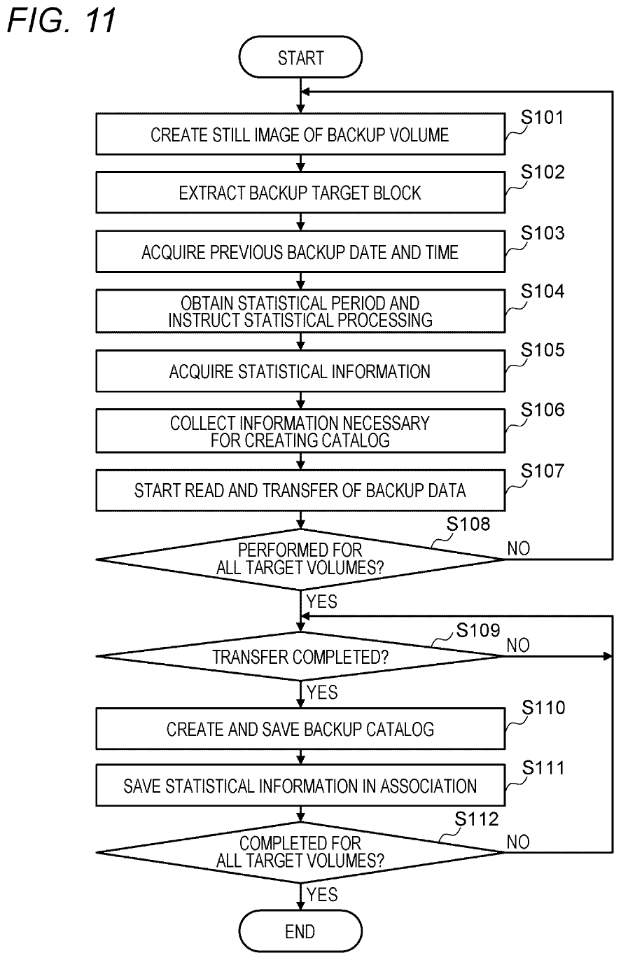

FIG. 11 is a flowchart illustrating backup processing according to the first embodiment. The backup processing is executed by the backup/restore control system 10 according to the setting content of the backup schedule on the backup setting screen D30 of FIG. 7.

First, in step S101, when the backup is started, the backup/restore control system 10 instructs the storage system 50 of the backup source system 20 to create a still image, that is, Snapshot of a logical volume of the backup target.

Next, in step S102, when the creation of Snapshot is completed, the backup/restore control system 10 instructs the storage system 50 to extract a difference of data blocks updated after the previous backup, and acquires update bitmap information representing the difference. The update bitmap information is, for example, information in which a Snapshot acquired previous time and a Snapshot acquired this time are compared in units of blocks, and a portion having an update is represented by 1 and a portion having no update is represented by 0.

Next, in step S103, the backup/restore control system 10 refers to its own information management database 2080 and the backup data store 40 to acquire the previous backup date and time. Next, in step S104, the backup/restore control system 10 determines start/end date and time of statistics from the previous backup date and time and the current backup date and time (each snapshot creation date and time), and instructs the storage system 50 to perform statistical processing. Next, in step S105, the backup/restore control system 10 acquires the statistical information 420C created by the statistical processing after completion of the statistical processing.

Next, in step S106, the backup/restore control system 10 collects information necessary for creating a catalog. The information necessary for creating the catalog includes, for example, a device serial number, a name and a defined capacity of a logical volume to be a backup target, a Snapshot number, and the like.

Next, in step S107, the backup/restore control system 10 reads the backup data from the Snapshot based on the update bitmap information (meta information) extracted in step S102. Then, the backup/restore control system 10 starts transfer to the backup data store 40 so as to save the backup data and the update bitmap information (backup start).

Next, in step S108, the backup/restore control system 10 determines whether the backup has been started for all the target volumes to be backed up in the current schedule. In a case where there is a logical volume for which backup has not been started (step S107 NO), the backup/restore control system 10 returns the processing to step S101. On the other hand, in a case where backup has been started in all the logical volumes (step S107 YES), the backup/restore control system 10 proceeds to step S109.

Next, in step S109, the backup/restore control system 10 determines whether the transfer of backup data to the backup data store 40 has been completed. In a case where the transfer of the backup data to the backup data store 40 has been completed for all the backups (step S109 YES), the backup/restore control system 10 proceeds to step S110. On the other hand, in a case where there is a backup for which the transfer of the backup data has not been completed (step S109 NO), the backup/restore control system 10 repeats step S109.

In step S110, the backup/restore control system 10 creates a backup catalog together with the information collected in step S106 and the information such as the size in the current backup. Then, the backup/restore control system 10 saves the data in the backup data store 40, its own information management database 2080, or the like. Next, in step S111, the backup/restore control system 10 saves the statistical information acquired and created in step S105 in association with the backup.

Next, in step S112, the backup/restore control system 10 confirms that the processing has been completed for all the target volumes. The backup/restore control system 10 ends the backup processing when the processing has been completed for all the target volumes, and returns the processing to step S109 and waits for transfer completion when the processing has not been completed (S112 NO).

### Configuration of Restore Setting Screen D40 According to First Embodiment

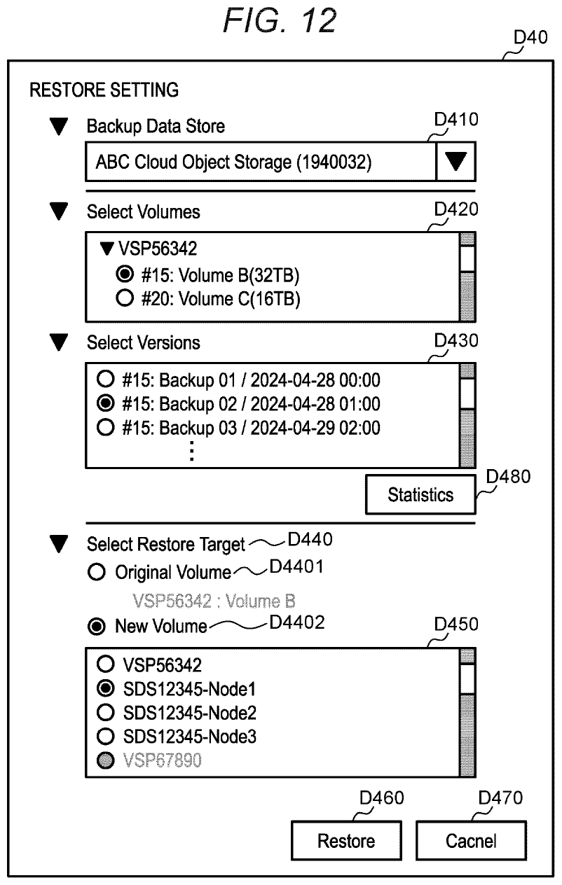

FIG. 12 is a diagram illustrating a configuration of a restore setting screen D40 according to the first embodiment. The restore setting screen D40 is provided by the GUI control program 2010.

The restore setting screen D40 includes a backup data store selection region D410, a volume selection region D420, a version (generation) selection region D430, a statistical information display button D480, and a restore destination selection region D440.

The backup data store selection region D410 is a region for selecting the backup data store 40 in which backup data to be used for restoration is stored, and the backup data store 40 registered in advance is displayed as an option by a drop-down box or the like. For example, in FIG. 12, “ABC Cloud Object Storage (1940032)” is selected.

The volume selection region D420 is a region for selecting a volume to be restored. Based on the selection in the backup data store selection region D410, the backup/restore control system 10 displays volume information obtained by searching the backup data store 40 or its own information management database 2080. In the example of FIG. 12, “Volume B (32 TB)” indicated by the logical volume number 15 backed up from “VSP56342” is selected.

The version (generation) selection region D430 is an item for selecting the backup data of the volume to be restored. The backup data filtered based on the selection of the volume selection region D420 is displayed. For example, in FIG. 12, the volume of the logical volume number 15 is selected in the volume selection region D420, and thus only the backup data of the logical volume number 15 is displayed in the version (generation) selection region D430. Then, in the version (generation) selection region D430, the second generation data indicated by “Backup 02” acquired at “2024-04-28 01:00” is selected to be restored.

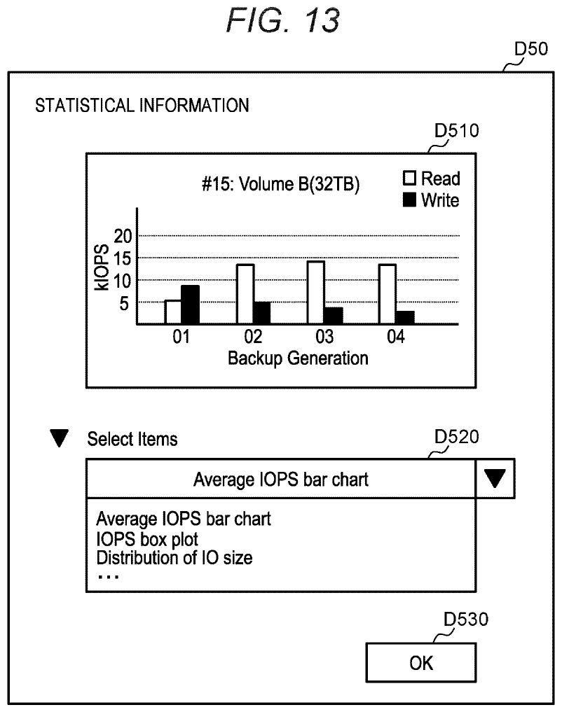

The statistical information display button D480 is a function of displaying the I/O statistics when the logical volume selected in the volume selection region D420 operated in the backup source storage device. The statistics display function will be described later with reference to FIG. 13.

The restore destination selection region D440 is an item for selecting a restore destination of the selected backup data. For example, in FIG. 12, restoration to a new volume D4402 is selected, and use of “SDS12345-Node1” as the creation destination of the same volume is selected in the selection region D450. Note that a device that is insufficient in capacity and restoration itself is not possible, such as “VSP67890” at the bottom stage of the selection region D450, cannot be selected as the restore destination.

The button D460 is pressed when the restoration of the backup data designated on the restore setting screen D40 is started. The button D470 is pressed when discarding the designated contents that had been designated on the restore setting screen D40.

Note that the restoration processing is a processing in which the backup/restore control system 10 reads the designated backup data from the backup data store 40 and writes the backup data to the designated restore destination volume by using the bitmap information (meta information) included in the backup data and the backed up block. Since it is a known technique, illustration and description thereof will be omitted.

### Configuration of Statistical Information Screen D50 According to First Embodiment

FIG. 13 is a diagram illustrating a configuration of the statistical information screen D50 according to the first embodiment. The statistical information screen D50 is separately displayed when the statistical information display button D480 (FIG. 12) is pressed on the restore setting screen D40. The statistical information screen D50 includes a graph display region D510 and a display content selection region D520.

The graph display region D510 is a region in which a graph is drawn according to content selected in a display content selection region to be described later. In the example of FIG. 13, the average IOPS for each backup generation of the volume of “Volume B (32 TB)” indicated by the logical volume number 15 is displayed as a bar graph, and it can be seen that the write I/O load to the volume is higher than the read I/O at the time point when the backup generation number 01 is acquired. On the other hand, in the generation number 02, it can be seen that the read I/O is stably high at slightly less than 15,000 IOPS (15 kIOPS), and the load of the write I/O is relatively small at 5,000 IOPS (5 kIOPS).

Therefore, if the volume of the generation number 02 is to be restored, it can be seen that it is necessary to restore to a storage system having I/O processing reserve capacity in which the read I/O is about 15 kIOPS and the write I/O is about 5 kIOPS. In addition, it can be seen that the I/O load of the generation later than the generation number 02 is stable, and the load does not tend to increase significantly.

The display content selection region D520 is a region in which an item to be depicted as a graph is selected based on the content included in the statistical information, and is displayed as an option in, for example, a drop-down box. In the example of FIG. 13, a bar graph of average IOPS, a box plot of IOPS, a distribution of IO sizes, and the like are defined as options, and a bar graph of average IOPS is selected.

The button D530 is pressed when terminating the viewing of the statistical information screen D50.

### Statistical Information Display Processing According to First Embodiment

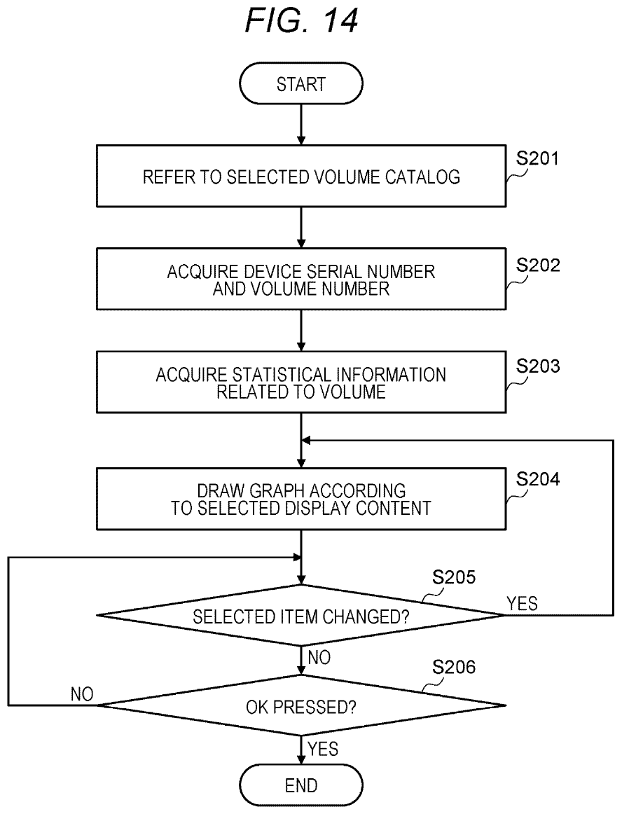

FIG. 14 is a flowchart illustrating statistical information display processing according to the first embodiment. The statistical information display processing is executed by the backup/restore control system 10 when the statistical information screen D50 illustrated in FIG. 13 is displayed.

First, in step S201, when the statistical information display button 480 is pressed on the restore setting screen D40 (FIG. 12), the backup/restore control system 10 refers to the catalog information of the selected backup volume. Next, in step S202, the backup/restore control system 10 acquires information for identifying statistical information such as a device serial number, a logical volume number, and a backup generation number.

Next, in step S203, the backup/restore control system 10 acquires related statistical information from the backup data store 40 or its own information management database 2080 based on the information acquired in steps S210 and S202. Next, in step S204, the backup/restore control system 10 draws a graph corresponding to the item selected in the display content selection region D520.

Next, in step S205, the backup/restore control system 10 determines whether the item selected in the display content selection region D520 has been changed. In a case where the item has been changed (step S205 YES), the backup/restore control system 10 returns the processing to step S204 and draws a new graph for the selected item. On the other hand, in a case where the item has not been changed (step S205 NO), the backup/restore control system 10 proceeds to step S206.

Next, in step S206, the backup/restore control system 10 determines whether the button D530 (OK button) has been pressed. In a case where the button D530 (OK button) has been pressed (step S206 YES), the backup/restore control system 10 closes the statistical information screen D50 and ends the statistical information display processing. On the other hand, in a case where the button D530 (OK button) has not been pressed (step S206 NO), the backup/restore control system 10 returns the processing to step S205 and continues the display unless the selected item is changed.

As described above, according to the present embodiment, the statistical information related to the I/O load when the target logical volume is operated is stored in association with the backup data, and this statistical information is referred to at the time of restoration. Therefore, it becomes possible to select an appropriate restore destination storage system based on the statistical information.

### Second Embodiment

In the first embodiment, at the time of restoration of the volume of the storage, an appropriate restore destination storage system can be selected by referring to the statistical information related to the target volume. However, it is assumed that determination and examination of an appropriate restore destination are performed by the user. On the other hand, in the second embodiment, a function of acquiring information on a storage system to be a candidate for the restore destination and presenting an appropriate restore destination is provided. Hereinafter, only differences from the first embodiment will be described, and description of similar configurations will be omitted.

### Configuration of Backup/Restore Control Program P25 According to Second Embodiment

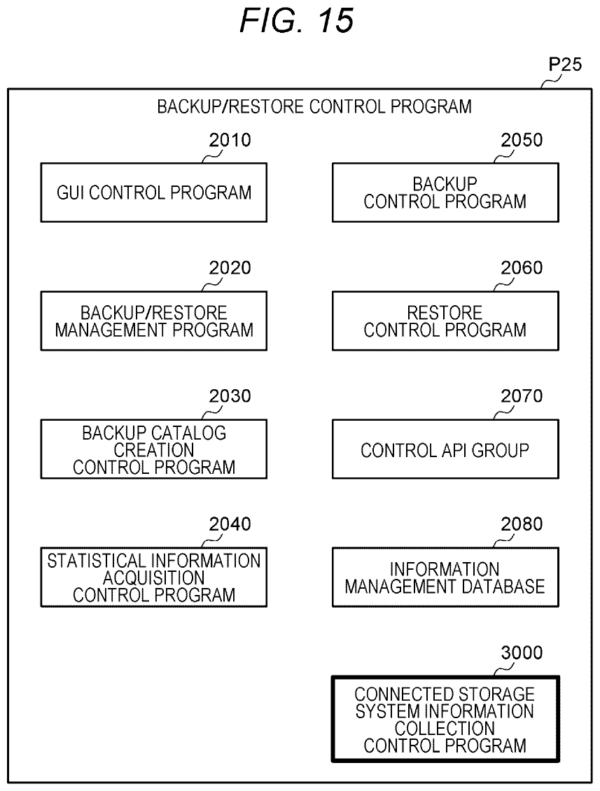

FIG. 15 is a diagram illustrating a configuration of a backup/restore control program P25 according to the second embodiment. The backup/restore control program P25 further includes a connected storage system information collection control program 3000 as compared with the backup/restore control program P20 of the first embodiment.

The connected storage system information collection control program 3000 acquires device information such as a vendor type and a model from the connected restore destination system 30. If the restore destination system 30 can be determined to be a support target based on the device information, the statistical information acquisition control program 2040 acquires information such as the performance of the device and the current IO load.

### Configuration of Restore Setting Screen D45 According to Second Embodiment

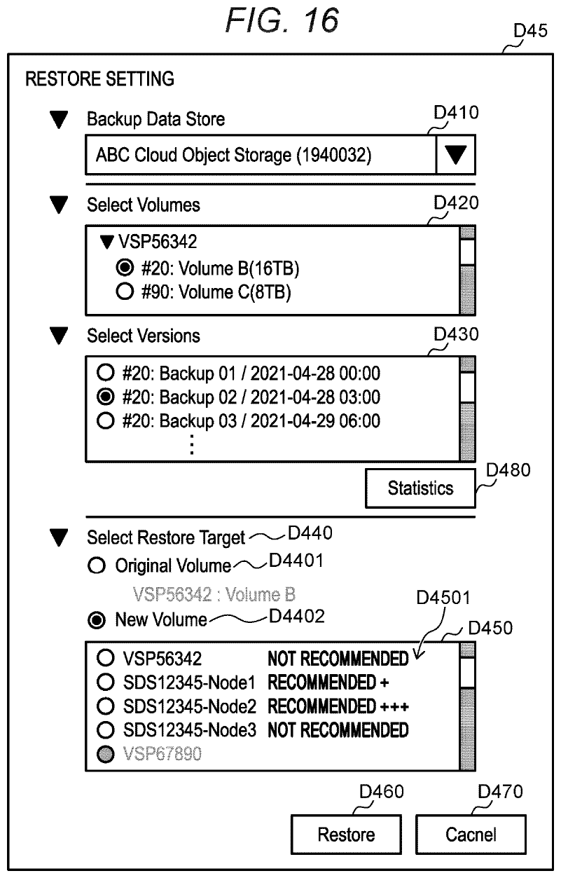

FIG. 16 is a diagram illustrating a configuration of a restore setting screen D45 according to the second embodiment. In the restore setting screen D45, when a new volume D4402 is selected in the restore destination selection region D440, a recommendation degree D4501 of each volume serving as the restore destination is displayed in the selection region D450.

### Recommendation Degree Determination Processing According to Second Embodiment

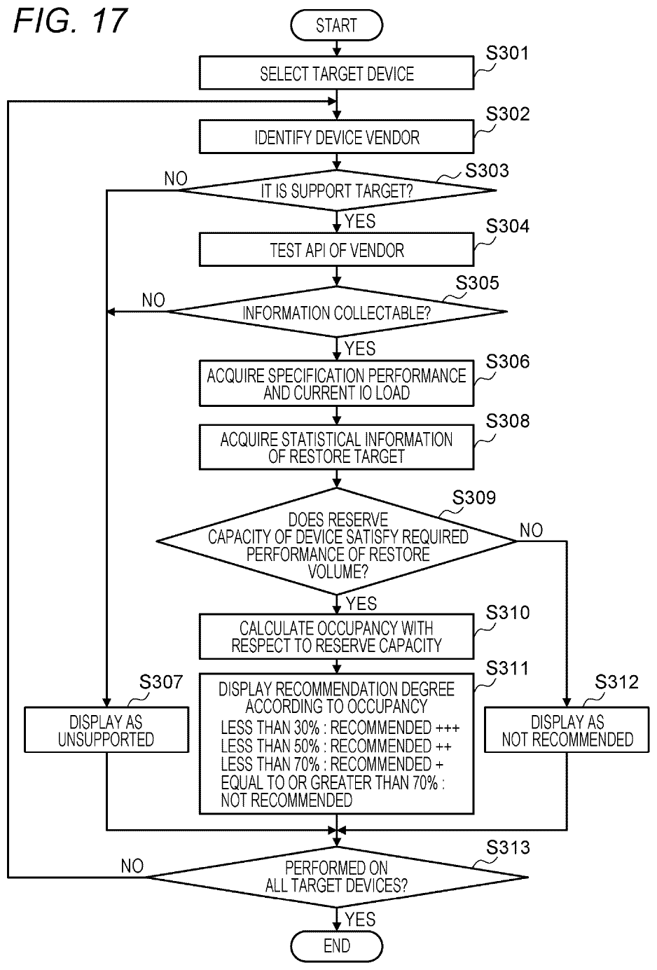

FIG. 17 is a flowchart illustrating recommendation degree determination processing according to the second embodiment. The recommendation degree determination processing is a processing in which the backup/restore control system 10 determines a recommendation degree. The recommendation degree determination processing is executed by the connected storage system information collection control program 3000 when the restore setting screen D45 is activated or before the restore setting screen D45 is activated for partial processing. Note that, in the selection region D450, a device having insufficient capacity and restoration itself is not possible is displayed so as not to be selectable as a restore destination, similarly to the first embodiment, and the recommendation degree determination processing is omitted, and the recommendation degree display is also omitted.

First, in step S301, the backup/restore control system 10 selects a target device to be subjected to information collection as a restore destination candidate of the volume. Next, in step S302, the backup/restore control system 10 acquires device information of the target device selected in step S301 by an iSCSI Discovery, an SCSI Inquiry command, or the like, and identifies a device vendor or the like. Note that the identification of the device vendor is not limited to the method using the command, and other methods may be used.

Next, in step S303, the backup/restore control system 10 determines whether or not the vendor is a support target from which information can be collected by this system. The backup/restore control system 10 proceeds to step S304 in a case where it is a support target (step S303 YES), and proceeds to step S307 in a case where it is not a support target (step S303 NO).

In step S304, the backup/restore control system 10 uses either the networks 3a and 3b or the data access networks 4a and 4b to try the API provided by the vendor. The backup/restore control system 10 proceeds to step S306 in a case where information can be collected (step S305 YES) As a result of the API trial. On the other hand, in a case where information cannot be collected (step S305 NO), the backup/restore control system 10 proceeds to step S307.

In step S306, the backup/restore control system 10 acquires information such as specification and performance of the device and a current IO load. On the other hand, in step S307, the backup/restore control system 10 determines that the device is to be displayed as unsupported. The specification performance is an example of performance information, and information such as an IO load and a free capacity of a storage capacity of a storage is an example of operating information.

Next, in step S309, the backup/restore control system 10 acquires statistical information related to the volume selected as the restore target. Next, in step S309, the backup/restore control system 10 compares the information on the device selectable as the restore destination with the statistical information, and determines whether the reserve capacity of the device satisfies the performance required by the volume to be restored. In a case where the volume to be restored satisfies the required performance (step S309 YES), the backup/restore control system 10 proceeds to step S310. On the other hand, in a case where the volume to be restored does not satisfy the required performance (step S309 NO), the backup/restore control system 10 proceeds to step S312.

In step S310, the backup/restore control system 10 calculates the occupancy of the required performance of the volume with respect to the reserve capacity of the volume of the restore destination. For example, if the device still has a reserve capacity of 100,000 IOPS and the volume to be restored is expected to consume 70,000 IOPS on average or at most, the occupancy is 70%.

Note that, as each value used for calculation of the occupancy, for example, an average value, a maximum value, or a 75% percentile value calculated based on a conditional expression set in the backup/restore control system 10 may be used. Alternatively, a value calculated based on a unique calculation formula by an arbitrary combination of various statistical values may be used.

Next, in step S311, the backup/restore control system 10 determines the recommendation degree to be displayed in accordance with the occupancy calculated in step S310. In the example of FIG. 17, in a case where it is less than 30%, that is, in a case where sufficient reserve capacity is still expected in the device even after restoration, it is determined to display “recommended +++” that is the highest recommendation degree, “recommended ++” that is the second highest recommendation degree when equal to or greater than 30% and less than 50%, “recommended +” that is the third highest recommendation degree when equal to or greater than 50% and less than 70%, and “not recommended” that is the lowest recommendation degree when equal to or greater than 70%.

On the other hand, in step S312, the backup/restore control system 10 determines to display “not recommended”.

Upon completion of steps S307, S311, and S312, in the subsequent step S313, the backup/restore control system 10 determines whether or not the processing of steps S301 to S312 has been performed on all the target devices. The backup/restore control system 10 ends the recommendation degree determination processing in a case where the processing of steps S301 to S312 has been performed on all the target devices (step S313 YES), and returns the processing to step S302 in a case where there is an unperformed target device (step S313 NO).

According to the present embodiment, when restoring to a new volume, it becomes possible to easily select which device is appropriate for restoration based on the operating information of the volume.

### First Modified Example of Second Embodiment

Although only the recommendation degree is displayed in the second embodiment, the free capacity of the device may be displayed together. In this case, the restore destination can be selected in consideration of both the capacity reserve capacity and the performance reserve capacity. For example, in a case where there are two devices of which the recommendation degree is both “recommended +++”, and one of the devices has the free capacity of 100 TB and the other has the free capacity of 10 TB, a device with the free capacity of 100 TB having more reserve capacity in the free capacity can be selected.

### Second Modified Example of Second Embodiment

In the second embodiment, the recommendation degree is displayed based on the occupancy of the I/O load, but in consideration of the first modified example, the recommendation degree may be displayed in consideration of both the occupancy of the I/O load and the free capacity.

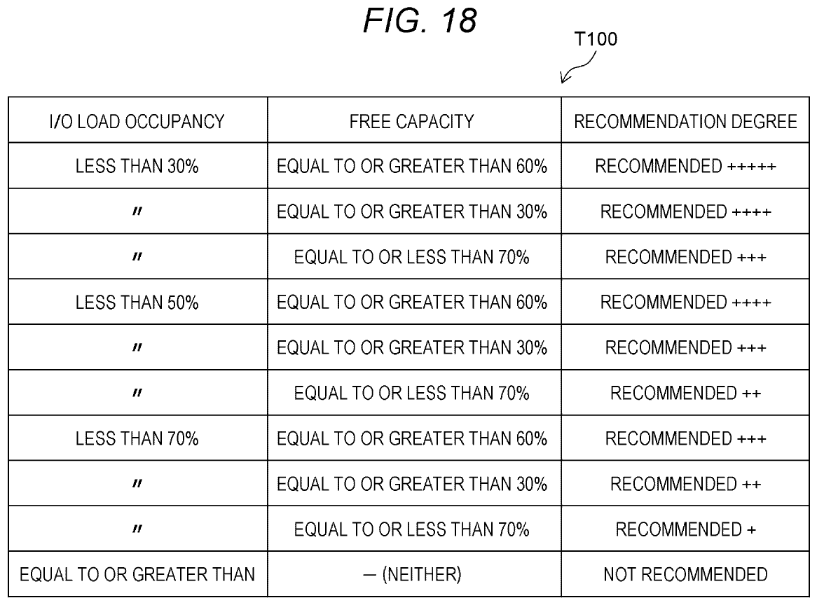

FIG. 18 is a diagram illustrating a configuration of a recommendation determination condition table T100 according to a second modified example of the second embodiment. As illustrated in FIG. 18, in the second modified example, the recommendation degree is determined in five stages. For example, in a case where the occupancy of the I/O load is less than 30% and the free capacity after restoration is expected to be equal to or greater than 60% with respect to the total capacity, “recommended +++” is displayed. Similarly, in a case where the occupancy of the I/O load is less than 30% and the free capacity after restoration is expected to be equal to or greater than 30%, “recommended +++” is displayed.

In a case where the occupancy of the I/O load is “equal to or greater than 70%”, the device is determined not suitable for the restore destination, and “not recommended” is displayed regardless of the free capacity.

Note that the recommendation determination condition table T100 substitutes for the determination criterion of the recommendation degree in S311 of FIG. 17. The free capacity reserve capacity after the restoration is calculated as “(B−C)/A” from (A) the total capacity of the restore destination device, (B) the current free capacity, and (C) the capacity consumed by the restoration.

### Third Modified Example of Second Embodiment

Although the recommendation degree is displayed in the second embodiment, the restore destination device may be automatically determined in addition to the display of the recommendation degree or instead of the display of the recommendation degree. For example, a device having the lowest I/O load occupancy can be automatically selected by the restore control program 2060 (FIG. 6).

Furthermore, in the second modified example of the second embodiment as well, similar achievement can be made as a device having the maximum free capacity among devices having the lowest I/O load occupancy is selected by the restore control program 2060 (FIG. 6). In this manner, it is possible to quickly select a storage system of an appropriate restore destination and perform restoration.

### Third Embodiment

In the second embodiment, there is one restore target (backup data), but in the third embodiment, processing in a case where a plurality of restore targets are to be restored will be described. Hereinafter, only differences from the second embodiment will be described, and description of similar configurations will be omitted.

### Configuration of Restore Setting Screen D60 According to Third Embodiment

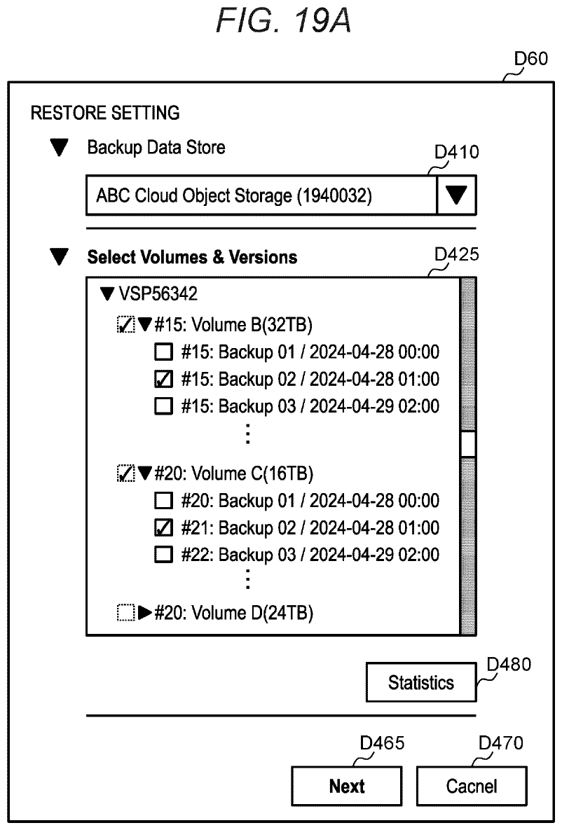

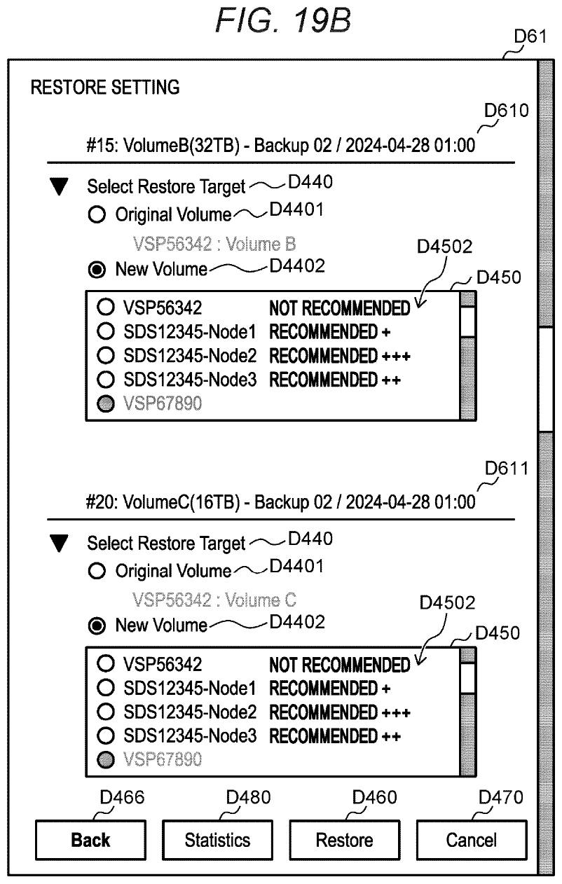

FIG. 19A is a diagram illustrating a configuration of a restore setting screen D60 according to the third embodiment. In the restore setting screen D60, instead of the volume selection region D420 and the version (generation) selection region D430 in the restore setting screen D40 (FIG. 12) according to the first embodiment, a volume and version (generation) selection region D425 in which both are integrated is provided. In the restore setting screen D60, a plurality of restore targets can be selected in the volume and version (generation) selection region D425. In addition, the restore setting screen D60 is provided with a “next” button D465 for transitioning to a restore setting screen D61 (FIG. 19B).

In the example of FIG. 19A, the second generation backup data indicated by “Backup 02” acquired at “2024-04-28 01:00” is selected among “Volume B (32 TB)” indicated by the logical volume number 15 backed up from “VSP56342”. Furthermore, the second generation backup data indicated by “Backup 02” acquired at “2024-04-28 01:00” is selected in “Volume C (16 TB)” indicated by the logical volume number 20. That is, two pieces of backup data are selected as restore targets. The selected backup data is displayed such that the volume and the version can be identified.

Then, when the button D465 is pressed, the screen transitions to a restore setting screen D61 (FIG. 19B) based on the selection result.

### Configuration of Restore Setting Screen D61 According to Third Embodiment

FIG. 19B is a diagram illustrating a configuration of the restore setting screen D61 according to the third embodiment. The restore setting screen D61 is a screen for selecting a restore destination. In the third embodiment, since a plurality of restore targets (backup data) can be selected, the restore setting screen D61 is provided with a restore destination selection region D440 for each previously selected backup data. In addition, the restore setting screen D61 is provided with a “return” button D466 for reversely transitioning to the restore setting screen D60.

In the example of FIG. 19B, a restore destination selection region D440 for the backup data D610 of “Volume B (32 TB)” of the logical volume number 15 and a restore destination selection region D440 for the backup data D611 of “Volume C (16 TB)” of the logical volume number 20 are provided. When the button D466 is pressed, the screen reversely transitions to the restore setting screen D60 (FIG. 19A), and backup data to be restored can be reselected again.

### Configuration of Statistical Information Screen D70 According to Third Embodiment

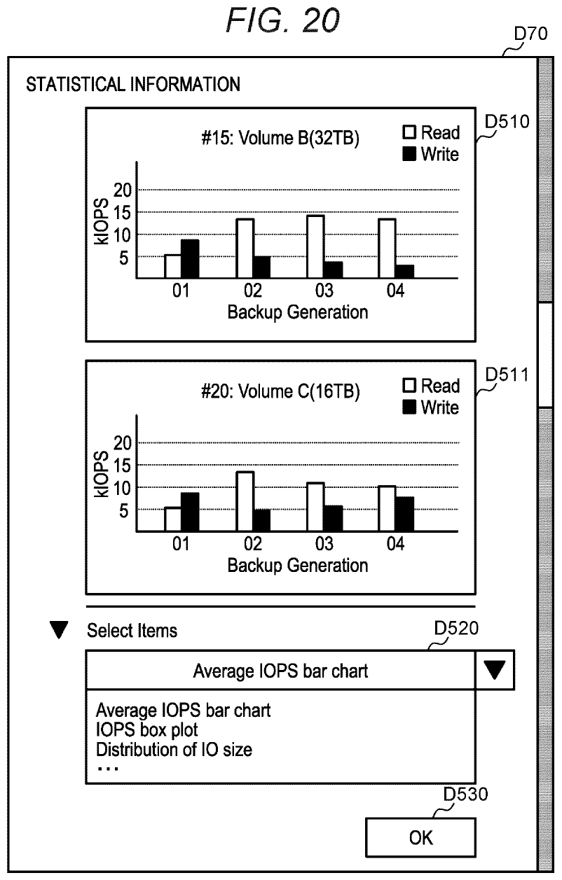

FIG. 20 is a diagram illustrating a configuration of the statistical information screen D70 according to the third embodiment. Similarly to the first and second embodiments, when the statistical information display button D480 of the restore setting screens D60 and D61 is pressed, the statistical information is separately displayed. In the third embodiment, since a plurality of pieces of backup data can be selected, graph display regions 510 and 511 or the like are provided on the statistical information screen D70 for each selected target volume. The drawing method of each graph is similar to that of the first and second embodiments, and the processing of FIG. 14 is repeated by the number of target volumes.

In the example of FIG. 20, since “Volume B (32 TB)” of the logical volume number 15 and “Volume C (16 TB)” of the logical volume number 20 are selected, two graphs are displayed.

### Recommendation Degree Update Processing According to Third Embodiment

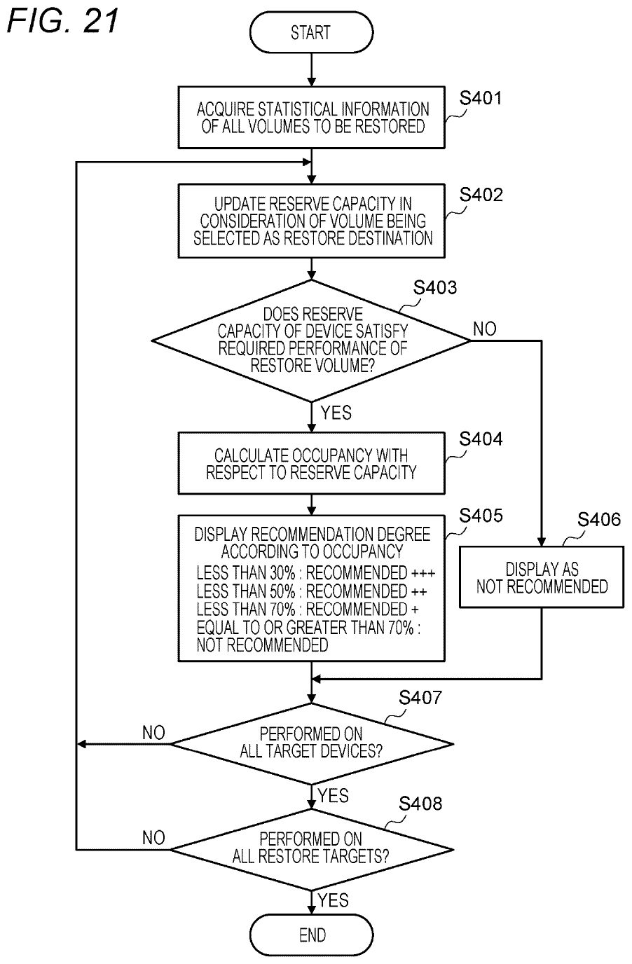

FIG. 21 is a flowchart illustrating a recommendation degree update processing according to the third embodiment. The recommendation degree update processing is a processing of updating the recommendation degree D4502 on the restore setting screen D61. The recommendation degree update processing is executed when any of the selection regions D450 is changed on the restore setting screen D61.

Note that the initial display of the restore setting screen D61 is performed by performing the recommendation degree determination processing (FIG. 17) of the second embodiment for each restore target. In addition, processing that need not be repeated if only performed once, such as the API test (step S304 (FIG. 17)) is omitted from the second and subsequent executions.

First, in step S401, the backup/restore control system 10 acquires the statistical information of all the volumes selected as the restore target in response to a change in selection of any of the recommendation degrees D4502 on the restore setting screen D61. Note that step S401 can be omitted in a case where it has already been acquired by the processing of FIG. 17 or the like.

Next, in step S402, in order to update the recommendation degree, the backup/restore control system 10 checks whether or not there is another restore target (backup data) for which the target device is selected as the restore destination, and updates the reserve capacity. For example, in a case where the device has reserve capacity to cover 100,000 IOPS, but another volume selected as the restore destination is expected to consume an average or a maximum of 40,000 IOPS, the reserve capacity is updated to 60,000 IOPS.

Since steps S403 to S406 are the same as steps S309 to S312 in FIG. 17, the description thereof will be omitted.

In step S407, the backup/restore control system 10 confirms whether all the target devices have been updated, that is, whether all the displays in the selection region D450 of a certain restore target have been updated. In a case where all the target devices have been updated (step S407 YES), the backup/restore control system 10 proceeds to step S408. On the other hand, in a case where some of the target devices have not been updated (step S407 NO), the backup/restore control system 10 returns the processing to step S402.

Next, in step S408, the backup/restore control system 10 confirms whether the update of the selection region D450 has been completed for all the restore targets, that is, all the backup data displayed on the restore setting screen D61. In a case where the update of the selection region D450 has been completed for all the restore targets (step S408 YES), the backup/restore control system 10 ends the recommendation degree update processing. On the other hand, in a case where the update of the selection region D450 has not been completed for all the restore targets (step S408 NO), the backup/restore control system 10 returns the processing to step S402.

### Screen Change of Restore Setting Screen D61 According to Third Embodiment

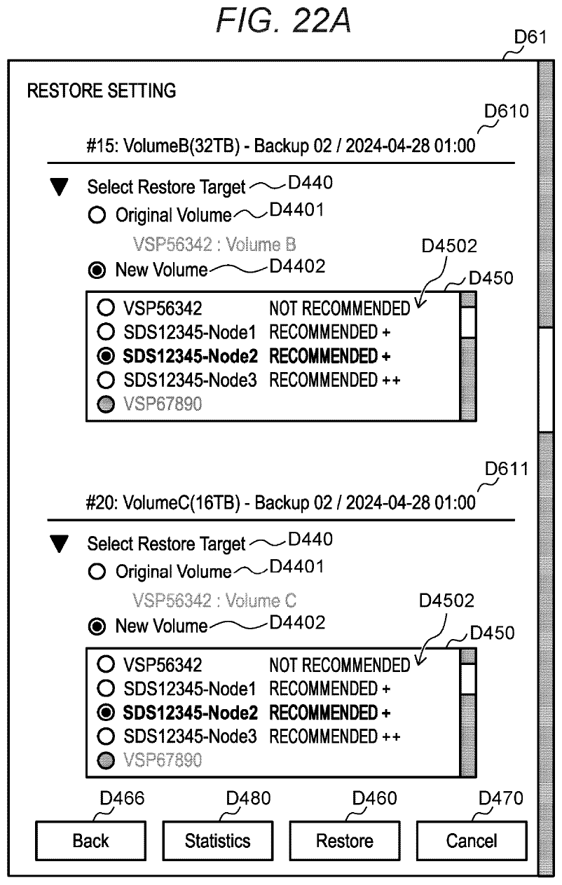

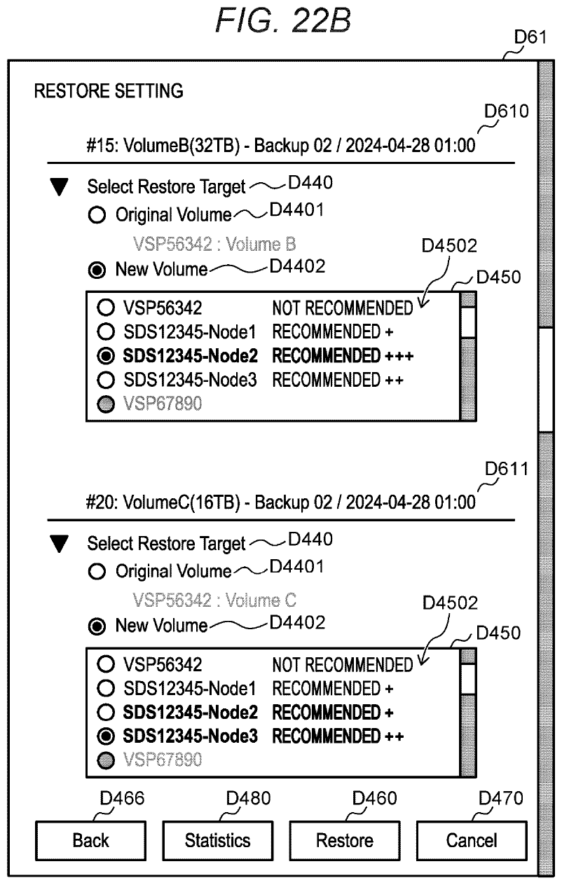

FIGS. 22A and 22B are diagrams illustrating screen changes of the restore setting screen D61 according to the third embodiment. FIG. 22A illustrates a state in which the processing of FIG. 21 is executed and the screen display of the restore setting screen D61 is updated in a case where “SDS12345-Node2” is selected as the restore destination of both the backup data D610 and D611 from the non-selected state of the restore destination device illustrated in FIG. 19B.

When the backup/restore control system 10 performs a reserve capacity update processing of “SDS12345-Node2” for the backup data D610 of the logical volume number 15 (step S402 (FIG. 21)), the reserve capacity is updated in consideration of the fact that “SDS12345-Node2” is selected as the restore destination of the backup data D611 of the logical volume number 20 that is another restore target. As a result, since the reserve capacity decreases, the recommendation degree of “SDS12345-Node2” on the restore setting screen D61 decreases from “recommended +++” to “recommended +”.

Similarly, the processing for the backup data D611 of the logical volume number 20 is similar. That is, since “SDS12345-Node2” is selected as the restore destination of the backup data D610 of the logical volume number 15, it is determined that the reserve capacity is small as a result of the reserve capacity update in step S402 (FIG. 21), and the recommendation degree “recommended +” is displayed.

The example of FIG. 22B is an example of a screen change in a case where the restore destination of the backup data D611 of the logical volume number 20 is changed to “SDS12345-Node3” from the state of FIG. 22A. Since the restore destination has been changed, the processing of FIG. 21 is executed again, and as a result, the screen is updated to the state of FIG. 22B.

In FIG. 22B, “recommended +++” is displayed as the recommendation degree of “SDS12345-Node2” serving as the restore destination of the backup data D610 of the logical volume number 15, as in the initial state. This is because other restore targets do not need to be taken into consideration in the reserve capacity update processing of “SDS12345-Node2” for the backup data D610 of the logical volume number 15 (step S402 (FIG. 21)).

On the other hand, in FIG. 22B, “recommended +” is continuously displayed as the recommendation degree of “SDS12345-Node2” serving as the restore destination of the backup data D611 of the logical volume number 20. This is because another restore target (the backup data D610 of the logical volume number 15) continuously needs to be taken into consideration in the reserve capacity update processing of “SDS12345-Node2” for the backup data D611 of the logical volume number 20.

According to the present embodiment, by trying appropriate selection combinations, an appropriate restore destination with reserve capacity can be selected even in a case where there are a plurality of restore targets.

### Modified Example of Third Embodiment

Although the recommendation degree is displayed in the third embodiment, the restore destination device may be automatically determined instead of displaying the recommendation degree as in the second embodiment. For example, it can be achieved by taking a method of performing an operation by the number of combinations of the restore target and the restore destination and selecting a combination in which the total of the recommendation degrees of all the devices is maximized (i.e., the arrangement balance is optimized). Furthermore, similarly to the first modified example and the second modified example of the second embodiment, the free capacity may also be taken into consideration in the third embodiment.

Although some embodiments have been described above, these are examples for describing the present invention, and it is not intended to limit the scope of the present invention only to these embodiments. The present invention can also be implemented in various other modes, for example, a mode in which a part of the configuration of each of the above-described embodiments is deleted, a mode in which at least a part of the configuration is replaced, a mode in which a configuration is added, and a mode in which a part or all of each of the embodiments is combined.

What is claimed is:

1. A backup/restore control system configured to control creation and restoration of backup of a volume included in a storage system, wherein
a processor included in the backup/restore control system is configured to:
control to create backup data of the volume to be backed up of a first storage system and store the backup data in a data store;
control to store I/O statistical information related to I/O of the volume created by the first storage system while associating the backup data and the I/O statistical information; and
control, in a case where a volume is restored using the backup data, to select a second storage system to be a restore destination of the volume from a plurality of storage systems based on the I/O statistical information, and restore a volume to be restored from the backup data to the second storage system.

2. The backup/restore control system according to claim 1, wherein the data store is a cloud data store.

3. The backup/restore control system according to claim 1, wherein
the processor is further configured to:
cause a display unit to display the I/O statistical information associated with the volume; and
select the second storage system to be a restore destination of the volume upon accepting an input of a user.

4. The backup/restore control system according to claim 1, wherein
the processor is further configured to:
select the second storage system from a plurality of storage systems based on the I/O statistical information and information on available resources of the plurality of storage systems serving as restore destination candidates.

5. The backup/restore control system according to claim 4, wherein
the information on the available resources of the storage systems serving as the restore destination candidates is performance information and operating information of the storage systems.

6. The backup/restore control system according to claim 5, wherein
the operating information is information related to an I/O load and a free capacity of a storage capacity.

7. The backup/restore control system according to claim 4, wherein
the processor is further configured to:
calculate a recommendation degree as the second storage system to be a restore destination of the volume for each of the storage systems based on the I/O statistical information and information on available resources of a plurality of storage systems serving as the restore destination candidates, and cause a display unit to display the recommendation degree, and
select the second storage system to be a restore destination of the volume upon accepting an input of a user.

8. The backup/restore control system according to claim 4, wherein
there are a plurality of volumes to be restored; and
the processor is further configured to:
select one or a plurality of the second storage systems to be the restore destination of the volume from a plurality of storage systems based on the I/O statistical information and information on available resources of the plurality of storage systems serving as the restore destination candidates.

9. The backup/restore control system according to claim 8, wherein
the processor is further configured to:
calculate a recommendation degree as the second storage system to be a restore destination of the volume for each of the storage systems based on the I/O statistical information and information on available resources of a plurality of storage systems serving as the restore destination candidates, and cause a display unit to display the recommendation degree,
select the second storage system to be a restore destination of the volume upon accepting an input of a user, and
change a recommendation degree as the second storage system to be a restore destination of another volume in a case where a storage system of a restore destination of one volume among a plurality of volumes to be restored is selected.

10. A backup/restore control method executed by a backup/restore control system configured to control creation and restoration of backup of a volume included in a storage system, wherein
a processor included in the backup/restore control system has processing of:
controlling to create backup data of the volume to be backed up of a first storage system and store the backup data in a data store;
controlling to store I/O statistical information related to I/O of the volume created by the first storage system while associating the backup data and the I/O statistical information; and
controlling, in a case where a volume is restored using the backup data, to select a second storage system to be a restore destination of the volume from a plurality of storage systems based on the I/O statistical information, and restore a volume to be restored from the backup data to the second storage system.
